(19) United States
(12) Patent Application Publication
(10) Pub. No.: US 2021/0137218 A1
(43) Pub. Date: May 13, 2021

(54) Footwear Identification Assembly

(71) Applicant: Jenny Tafoya, Denver, CO (US)

(72) Inventor: Jenny Tafoya, Denver, CO (US)

(21) Appl. No.: 16/682,397

(22) Filed: Nov. 13, 2019

(51) Int. Cl. A43B 23/24

(52) U.S. Cl. CPC A43B 23/24

(57) ABSTRACT

A footwear identification assembly for assisting in proper positioning of footwear upon feet of a user includes a pair of plates. Indicia are coupled to and extend from at least one opposing face of each plate so that one plate comprises a left descriptor and the other plate comprises a right descriptor. Each of a pair of couplers is coupled to a respective plate so that the coupler is configured to couple the respective plate to an associated article of footwear. The left descriptor and the right descriptor are configured to allow visual and tactile identification of articles of footwear to facilitate proper positioning of the articles of footwear on a left foot and a right foot of a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to identification assemblies and more particularly pertains to a new identification assembly for assisting in proper positioning of footwear upon feet of a user.

### (2) Description of Related Art Including Information Disclosed Under 37 CFR 1.97 and 1.98

The prior art relates to identification assemblies. Prior art identification assemblies may comprise plates having raised lettering and a rim.

### BRIEF SUMMARY OF THE INVENTION

An embodiment of the disclosure meets the needs presented above by generally comprising a pair of plates. Indicia are coupled to and extend from at least one opposing face of each plate so that one plate comprises a left descriptor and the other plate comprises a right descriptor. Each of a pair of couplers is coupled to a respective plate so that the coupler is configured to couple the respective plate to an associated article of footwear. The left descriptor and the right descriptor are configured to allow visual and tactile identification of articles of footwear to facilitate proper positioning of the articles of footwear on a left foot and a right foot of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a footwear identification assembly according to an embodiment of the disclosure.

FIG. 2 is a bottom view of an embodiment of the disclosure.

FIG. 3 is a side view of an embodiment of the disclosure.

FIG. 4 is a side view of an embodiment of the disclosure.

FIG. 5 is an end view of an embodiment of the disclosure.

FIG. 6 is an end view of an embodiment of the disclosure.

FIG. 7 is an isometric perspective view of an embodiment of the disclosure.

FIG. 8 is an in-use view of an embodiment of the disclosure.

### DETAILED DESCRIPTION OF THE INVENTION

With reference now to the drawings, and in particular to FIGS. 1 through 8 thereof, a new identification assembly embodying the principles and concepts of an embodiment of the disclosure and generally designated by the reference numeral 10 will be described.

As best illustrated in FIGS. 1 through 8, the footwear identification assembly 10 generally comprises a pair of plates 12. The plates 12 may be circularly shaped, or may be alternatively shaped, such as, but not limited to, ovally shaped, squarely shaped, and the like. The plates 12 may comprise at least one of metal, wood, and plastic so that the plates 12 are substantially rigid. The present invention also anticipates the plates 12 comprising flexible material, such as, but not limited to, fabric, plastic, and the like. The plates 12 of the pair of plates 12 may be differentially colored so that the plates 12 are visually distinguishable.

Indicia 14 are coupled to and extend from at least one opposing face 16 of each plate 12 so that one plate 12 comprises a left descriptor 18 and the other plate 12 comprises a right descriptor 20. The left descriptor 18 and the right descriptor 20 comprise characters 22 selected from at least one of the group of language writing systems. The left descriptor 18 and the right descriptor 20 may comprise characters 22 selected from the English writing system, as shown in FIG. 7. The indicia 14 may be substantially centrally positioned on the at least one opposing face 16 of each plate 12.

Each of a pair of couplers 24 is coupled to a respective plate 12 so that the coupler 24 is configured to couple the respective plate 12 to an associated article of footwear 26. The left descriptor 18 and the right descriptor 20 are configured to allow visual and tactile identification of articles of footwear 26 to facilitate proper positioning of the articles of footwear 26 on a left foot and a right foot of a user.

The coupler 24 may comprise an aperture 28 that is configured for insertion of a lace of the associated article of footwear 26 to couple the respective plate 12 to the associated article of footwear 26, as shown in FIG. 8. The aperture 28 may be positioned proximate to a perimeter 30 of the respective plate 12, as shown in FIG. 2. The aperture 28 may be circularly shaped, or may be alternatively shaped, such as, but not limited to, ovally shaped, squarely shaped, and the like.

The present invention also anticipates the coupler 24 comprising other coupling means, such as, but not limited to, hook and loop fasteners, pressure sensitive adhesives, and the like. For example, use of a pressure sensitive adhesive would allow the respective plate 12 to be positioned discretely on an inner surface of the associated article of footwear 26.

In use, each plate 12 is coupled to its associated article of footwear 26 by inserting the lace of the associated article of footwear 26 through the aperture 28 that is positioned in the plate 12. The left descriptor 18 and the right descriptor 20 allow for visual and tactile identification of the articles of footwear 26 to facilitate proper positioning of the articles of footwear 26 on the left foot and the right foot of the user. The assembly 10 is anticipated to be useful to young children, not only in properly positioning the articles of footwear 26, but in learning the general concept of Left and Right. Additionally, the assembly 10 is anticipated to be useful to a user having a developmental disability or a visual impairment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A footwear identification assembly comprising:
a pair of plates;
indicia coupled to and extending from at least one opposing face of each plate such that one plate comprises a left descriptor and the other plate comprises a right descriptor; and
a pair of couplers, each coupler being coupled to a respective plate wherein the coupler is configured for coupling the respective plate to an associated article of footwear wherein the left descriptor and the right descriptor are configured for visual and tactile identification of articles of footwear for properly positioning the articles of footwear on a left foot and a right foot of a user.

2. The assembly of claim 1, further including the plates being circularly shaped.

3. The assembly of claim 1, further including the plates comprising at least one of metal, wood, and plastic such that the plates are substantially rigid.

4. The assembly of claim 1, further including the plates of the pair of plates being differentially colored such that the plates are visually distinguishable.

5. The assembly of claim 1, further including the left descriptor and the right descriptor comprising at least one of a full word and an abbreviation for indicating Left and the right descriptor comprising at least one of a full word and an abbreviation for indicating Right.

6. The assembly of claim 1, further including the left descriptor and the right descriptor comprising characters selected from at least one of the group of language writing systems.

7. The assembly of claim 6, further including the left descriptor and the right descriptor comprising characters selected from the English writing system.

8. The assembly of claim 1, further including the indicia being substantially centrally positioned on the at least one opposing face of each plate.

9. The assembly of claim 1, further including the coupler comprising an aperture wherein the aperture is configured for inserting a lace of the associated article of footwear for coupling the respective plate to the associated article of footwear.

10. The assembly of claim 9, further including the aperture being positioned proximate to a perimeter of the respective plate.

11. The assembly of claim 9, further including the aperture being circularly shaped.

12. A footwear identification assembly and footwear combination comprising:
a pair of articles of footwear configured for positioning on a left foot and a right foot of a user;
a pair of plates, each plate being coupled to a respective article of footwear; and
indicia coupled to and extending from at least one opposing face of each plate such that one plate comprises a left descriptor and the other plate comprises a right descriptor wherein the left descriptor and the right descriptor are configured for visual and tactile identification of the articles of footwear for properly positioning the articles of footwear on the left foot and the right foot of the user.

13. A footwear identification assembly comprising:
a pair of plates, the plates being circularly shaped, the plates comprising at least one of metal, wood, and plastic such that the plates are substantially rigid, the plates of the pair of plates being differentially colored such that the plates are visually distinguishable;
indicia coupled to and extending from at least one opposing face of each plate such that one plate comprises a left descriptor and the other plate comprises a right descriptor, the left descriptor and the right descriptor comprising characters selected from at least one of the group of language writing systems, the indicia being substantially centrally positioned on the at least one opposing face of each plate; and
a pair of couplers, each coupler being coupled to a respective plate wherein the coupler is configured for coupling the respective plate to an associated article of footwear wherein the left descriptor and the right descriptor are configured for visual and tactile identification of articles of footwear for properly positioning the articles of footwear on a left foot and a right foot of a user, the coupler comprising an aperture wherein the aperture is configured for inserting a lace of the associated article of footwear for coupling the respective plate to the associated article of footwear, the aperture being positioned proximate to a perimeter of the respective plate, the aperture being circularly shaped.

14. The assembly of claim 13, further including the left descriptor and the right descriptor comprising characters selected from the English writing system.
